(19) United States
(12) Patent Application Publication
(10) Pub. No.: US 2025/0039759 A1
(43) Pub. Date: Jan. 30, 2025

(54) METHOD FOR PROCESSING RESOURCES, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Yang LIU, Dongguan (CN)

(21) Appl. No.: 18/911,461

(22) Filed: Oct. 10, 2024

Related U.S. Application Data
(63) Continuation of application No. PCT/CN2022/103420, filed on Jul. 1, 2022.

(51) Int. Cl. H04W 36/30; H04W 36/08

(52) U.S. Cl. CPC H04W 36/305; H04W 36/08

(57) ABSTRACT

Provided is a method for processing resources. The method is applicable to a terminal device. The method includes the following processes: generating first information, wherein the first information includes a primary secondary cell change report; and transmitting the first information. The terminal device includes: a processor and a memory, wherein the memory is configured to store one or more computer programs, wherein the processor, when loading and running the one or more computer programs stored in the memory, causes the terminal device to perform the method.

### CROSS-REFERENCE TO RELATED APPLICATION

This application is a continuation application of international application No. PCT/CN2022/103420, filed on Jul. 1, 2022, the entire contents of which are incorporated herein by reference.

### TECHNICAL FIELD

Embodiments of the present disclosure relate to the field of communications, and in particular, relate to a method for processing resources, and a terminal device and a network device thereof.

### BACKGROUND

In a dual connectivity (DC) scenario, a master node (MN) or a secondary node (SN) may initiate a conditional primary secondary cell (PSCell) change.

### SUMMARY

Embodiments of the present disclosure provide a method for processing resources, and a terminal device and a network device thereof.

According to some embodiments of the present disclosure, a method for processing resources is provided. The method is applicable to a terminal device. The method includes: generating first information, wherein the first information includes a primary secondary cell change report; and transmitting the first information.

According to some embodiments of the present disclosure, a terminal device is provided. The terminal device includes a processor and a memory, wherein the memory is configured to store one or more computer programs. The processor, when loading and running the one or more computer programs stored in the memory, causes the terminal device to perform the method described above.

According to some embodiments of the present disclosure, a network device is provided. The network device includes a processor and a memory, wherein the memory is configured to store one or more computer programs. The processor, when loading and running the one or more computer programs stored in the memory, causes the network device to perform: receiving first information, wherein the first information comprises a primary secondary cell change report.

### BRIEF DESCRIPTION OF THE DRAWINGS

FIG. 1 is a schematic diagram of a communication system architecture applicable to the embodiments of the present disclosure;

FIG. 2 is a schematic diagram of dual connectivity according to some embodiments of the present disclosure;

FIG. 3 is a schematic flowchart of an MN-initiated conditional SN change according to some embodiments of the present disclosure;

FIG. 4 is a schematic flowchart of an SN-initiated conditional SN change according to some embodiments of the present disclosure;

FIG. 5 is a schematic diagram of a conventional primary secondary cell change and a conditional primary secondary cell change according to some embodiments of the present disclosure;

FIG. 6 is a schematic interaction flowchart of a method for processing resources according to some embodiments of the present disclosure;

FIG. 7 is a schematic block diagram of a terminal device according to some embodiments of the present disclosure;

FIG. 8 is a schematic block diagram of a network device according to some embodiments of the present disclosure;

FIG. 9 is a schematic block diagram of a communication device according to some embodiments of the present disclosure;

FIG. 10 is a schematic block diagram of an apparatus according to some embodiments of the present disclosure; and

FIG. 11 is a schematic block diagram of a communication system according to some embodiments of the present disclosure.

### DETAILED DESCRIPTION

The technical solutions according to embodiments of the present disclosure are described hereinafter with reference to the accompanying drawings in the embodiments of the present disclosure. It is obvious that the described embodiments are only a part, but not all of the embodiments of the present disclosure. All other embodiments derived by those of ordinary skills in the art without creative efforts based on the embodiments in the present disclosure shall fall within the protection scope of the present disclosure.

The technical solutions according to the embodiments of the present disclosure are applicable to various communication systems, for example, a global system of mobile communication (GSM) system, a code division multiple access (CDMA) system, a wideband code division multiple access (WCDMA) system, a general packet radio service (GPRS) system, a long-term evolution (LTE) system, an advanced long-term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial networks (NTN) system, an universal mobile telecommunication system (UMTS), a wireless local area networks (WLAN) system, an Internet of things (IoT) system, a wireless fidelity (Wi-Fi) system, a 5^{th} generation (5G) system, a 6^{th} generation (6G) system, or other communication systems.

Generally, a conventional communication system supports a limited number of connections and is easy to implement. However, with the development of communication technology, the mobile communication system supports conventional communications and other communications, for example, device-to-device (D2D) communications, machine-to-machine (M2M) communications, machine-type communications (MTC), vehicle-to-vehicle (V2V) communications, sidelink (SL) communications, vehicle-to-everything (V2X) communications, and the like. The communication systems are applicable to the embodiments of the present disclosure.

In some embodiments, the communication system in the embodiments of the present disclosure is applicable to a carrier aggregation (CA) scenario, a dual connectivity (DC) scenario, a standalone (SA) networking scenario, or a non-standalone (NSA) networking scenario.

In some embodiments, the communication system in the embodiments of the present disclosure is applicable to an unlicensed spectrum. The unlicensed spectrum is also construed as a shared spectrum. Alternatively, the communication system in the embodiments of the present disclosure is applicable to a licensed spectrum. The licensed spectrum is also construed as a non-shared spectrum.

In some embodiments, the communication system in the embodiments of the present disclosure is applicable to the FRI frequency band (corresponding to the frequency range of 410 MHz to 7.125 GHZ), the FR2 frequency band (corresponding to the frequency range of 24.25 GHZ to 52.6 GHZ), or new frequency bands such as the high-frequency band corresponding to the frequency range of 52.6 GHz to 71 GHz or the frequency range of 71 GHz to 114.25 GHZ.

The embodiments of the present disclosure are described in conjunction with a network device and a terminal device. The terminal device may also be referred to as a user equipment (UE), an access terminal, a subscriber unit, a subscriber station, a mobile station, a mobile terminal, a remote station, a remote terminal, a mobile device, a user terminal, a terminal, a wireless communication device, a user agent, a user apparatus, or the like.

The terminal device may be a station (ST) in WLAN, a cellular phone, a cordless phone, a Session Initiation Protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next generation communication system, such as a terminal device in an NR network, or a terminal device in an evolved public land mobile network (PLMN), or the like.

In the embodiments of the present disclosure, the terminal device may be deployed on land, for example, indoors or outdoors, handheld, wearable or vehicle-mounted; or deployed on water (for example, a ship); or deployed in the air (for example, an airplane, a balloon, or a satellite).

In the embodiments of the present disclosure, the terminal device is a mobile phone, a pad, a computer with wireless transceiver functionality, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city or smart home, an in-vehicle communication device, a wireless communication chip/application specific integrated circuits (ASIC)/system on chip (SoC), or the like.

By way of example and not limitation, in the embodiments of the present disclosure, the terminal device may be a wearable device. The wearable device is also referred to as a wearable smart device, and is a generic name of wearable devices such as glasses, gloves, watches, clothing, and shoes, which are intelligently designed and developed for daily wear using wearable technologies. The wearable device is a portable device that is either worn directly on the body or integrated into the clothing or accessories of the user. The wearable device is not just a hardware device, but also implements powerful functions by software support, data interaction, and cloud interaction. The wearable smart device in a broad sense includes devices such as smart watches or smart glasses that have full functionality and larger size, and are capable of implementing all or part of functionality independently of smart phone, and devices such as various kinds of smart bracelets and smart jewelries for monitoring physical signs, which are dedicated to a specific type of application functions and need to be used in conjunction with other devices like smart phone.

In the embodiments of the present disclosure, the network device may be a device for communicating with the mobile device. The network device may be an access point (AP) in a WLAN, a base transceiver station (BTS) in GSM or CDMA, a NodeB (NB) in WCDMA, an evolved NodeB (eNB or eNodeB) in LTE, or a relay station or an AP. The network device may also be an in-vehicle device, a wearable device, a network device or a base station (gNB) in an NR network, a transmission reception point (TRP), a network device in an evolved PLMN network or an NTN network, or the like.

By way of example and not limitation, in the embodiments of the present disclosure, the network device may be mobile. For example, the network device is a mobile device. In some embodiments, the network device is a satellite or a balloon station. For example, the satellite is a low Earth orbit (LEO) satellite, a medium Earth orbit (MEO) satellite, a geostationary Earth orbit (GEO) satellite, a high elliptical orbit (HEO) satellite, or the like. In some embodiments, the network device is also a base station located on land, in water, or the like.

In the embodiments of the present disclosure, the network device may provide a service for a cell, and a terminal device communicates with the network device over a transmission resource (e.g., a frequency domain resource or a frequency spectrum resource) used in the cell. The cell is a cell corresponding to the network device (e.g., a base station), and the cell may belong to a macro base station or to a base station corresponding to a small cell. The small cell includes: a metro cell, a micro cell, a pico cell, a femto cell, or the like. The small cells have the characteristics of small coverage and low transmission power, and are suitable for providing high-rate data transmission services.

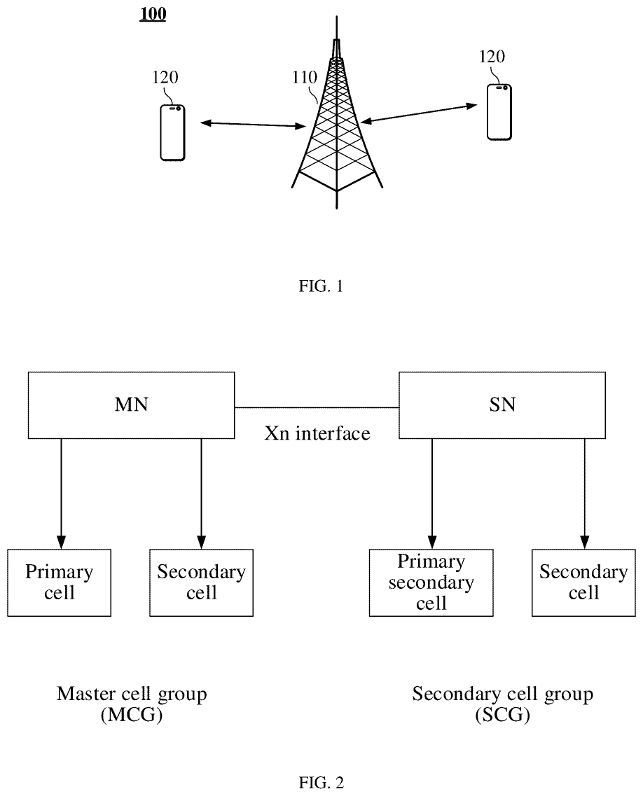

Exemplarily, a communication system 100 applicable to the embodiments of the present disclosure is illustrated in FIG. 1. The communication system 100 includes a network device 110, and the network device 110 is a device communicating with a terminal device 120 (or referred to as a communication terminal, or a terminal). The network device 110 provides communication coverage to a specific geographical area, and communicates with terminal device located within the coverage area.

FIG. 1 exemplarily illustrates one network device and two terminal devices. In some embodiments, the communication system 100 includes a plurality of network devices and each network devices covers other numbers of terminal devices, which is not limited in the embodiments of the present disclosure.

In some embodiments, the communication system 100 further includes a network controller, a mobile management entity, or other network entities, such as a user plane function (UPF), an access and mobility management function (AMF), a session management function (SMF), or the like, which is not limited in the embodiments of the present disclosure.

It should be understood that a device having a communication function in the network/system in the embodiments of the present disclosure may be referred to as a communication device. By taking the communication system 100 shown in FIG. 1 as an example, the communication device includes a network device 110 and a terminal device 120 that have a communication function, and the network device 110 and the terminal device 120 are devices that have been specifically described above, which are not described herein any further. The communication device further includes other devices in the communication system 100, for example, a network controller, a mobile management entity, or other network entities, which is not limited in the embodiments of the present disclosure.

It should be understood that the terms “system” and “network” herein are often used interchangeably. The term “and/or” herein describes the relationship between associated objects, and indicates three types of relationships. For example, the phrase “A and/or B” means (A), (B), or (A and B). In addition, the symbol “/” herein generally indicates an “or” relationship between the associated objects.

It should be understood that a first communication device and a second communication are involved herein. The first communication device may be a terminal device, such as a mobile phone, a machine facility, a customer premise equipment (CPE), an industrial equipment, and a vehicle. The second communication device may be the counterpart communication device of the first communication device, such as a network device, a mobile phone, an industrial equipment, and a vehicle. In the embodiments of the present disclosure, the first communication device is a terminal device, and the second communication device is a network device (i.e., uplink communication or downlink communication). Alternatively, the first communication device is a first terminal, and the second communication device is a second terminal (i.e., sidelink communication).

The terms in the embodiments of the present disclosure are only intended to explain the specific embodiments of the present disclosure and are not intended to limit the present disclosure. The terms “first,” “second,” “third,” “fourth,” and the like in the description, claims and accompanying drawings of the present disclosure are used to distinguish different objects and are not used to indicate specific order. Furthermore, the terms “comprise” and “include” as well as any variations thereof are intended to cover non-exclusive inclusion.

It should be understood that the term “indication” in the embodiments of the present disclosure is a direct indication, an indirect indication, or an indication that there is an association relationship. For example, “A indicates B” may mean that A indicates B directly, e.g., B may be acquired through A; or that A indicates B indirectly, e.g., A indicates C through which B may be acquired; or that an association relationship is present between A and B.

In the description of the embodiments of the present disclosure, the term “correspond” indicates a direct or indirect corresponding relationship between two items, or indicates an associated relationship between the two items. It may also indicate relationships such as indicating and being indicated, configuring and being configured, or the like.

In the embodiments of the present disclosure, the term “predefined” or “preconfigured” may be implemented by pre-storing the corresponding codes, tables, or other means for indicating relevant information in the devices (e.g., including terminal devices and network devices). The present disclosure does not limit the specific implementation methods thereof. For example, the term “predefined” refers to “defined” in protocols.

In the embodiments of the present disclosure, the term “protocol” may refer to standards or protocols in the field of communications, such as the evolution of LTE protocols, NR protocols, Wi-Fi protocols, or other related communication system protocols, which are not limited in the present disclosure.

For facilitating understanding of the technical solutions according to the embodiments of the present disclosure, the technical solutions of the present disclosure are described in detail below with specific embodiments. As an alternative, the following related technologies may be combined with the technical solutions according to the embodiments of the present disclosure in any manner, all of which fall within the protection scope of the embodiments of the present disclosure. The embodiments of the present disclosure include at least part of the following content.

For a better understanding of the embodiments of the present disclosure, dual connectivity related to the present disclosure is explained.

Specifically, as shown in FIG. 2, a dual connectivity system may include a master cell group (MCG) and a secondary cell group (SCG). The dual connectivity system may include: a master node (MN), a secondary node (SN), a primary cell (PCell) in the master node, a secondary cell (SCell) in the master node, a primary secondary cell (PSCell) in the secondary node, and a secondary cell (SCell) in the secondary node. The dual connectivity is to improve the throughput for terminals that have already accessed the primary cell and are in a connected state, and hence to provide additional spectrum resources for terminals by the cells on the SN.

For a better understanding of the embodiments of the present disclosure, the process of conditional primary secondary cell (PSCell) change related to the present disclosure is explained.

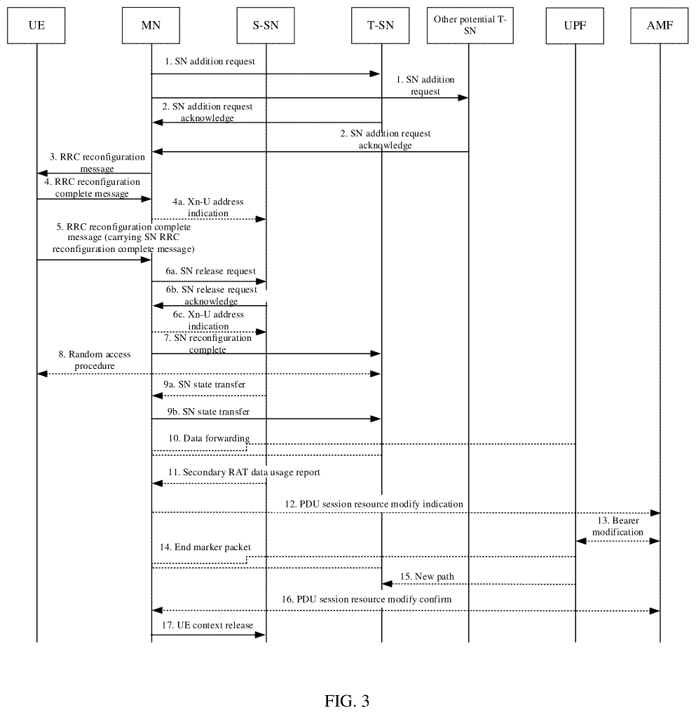

In some embodiments, the MN-initiated conditional SN change is as shown in FIG. 3. The MN-initiated conditional SN change process for configuring conditional PSCell change (CPC) configuration primarily includes the following steps.

1/2. The MN first requests the candidate SN to reserve resources for the terminal. Additionally, the MN provides the candidate SN with a list of candidate cells, such that the candidate SN reserves resources on the cells further selected. In addition to providing the resources of the PSCell, the SN also provides the MN with the corresponding new SCG radio resource configuration (RRC reconfiguration (RRCReconfiguration***)), which is carried in a secondary gNB (SgNB) addition acknowledgment (ACK) message. Furthermore, in the case that data forwarding is required, the target SN transmits the forwarding address to the MN.

3. The MN transmits the list including configuration information of the CPC (i.e., including the RRC connection reconfiguration (RRCConnectionReconfiguration**)) and the corresponding primary secondary cell change conditions to the terminal. The RRCConnectionReconfiguration** includes the RRCReconfiguration*** configuration information of the candidate SN and the existing MCG update configuration information (including the measurement configuration information that needs to be executed).

4. The terminal applies the RRC configuration included in the RRCConnectionReconfiguration* in addition to the CPC configuration, stores the CPC configuration information, and replies to the MN with an RRC connection reconfiguration complete (RRCConnectionReconfigurationComplete) message.

4a. Upon receiving the RRCConnectionReconfigurationComplete message from the terminal, the MN initiates the data forwarding address indication procedure to instruct the SN to start the CPC process. If possible, the SN may initiate early data forwarding.

5. The UE starts evaluating the execution conditions. In the case that the execution condition of one candidate PSCell is met, the terminal applies the RRCConnctionReconfiguration signaling (RRCConnectionReconfiguration**) of the selected candidate cell, and transmits the RRCConnectionReconfigurationComplete signaling (including the information of the selected PSCell) to the MN.

6a-6c. The MN instructs the source SN to stop transmitting user information to the UE through the SN release procedure, and transmits the address of the selected target SN to the source SN, to facilitate the data forwarding by the source SN.

7. In the case that the RRC connection reconfiguration process in step 5 is successful, the MN instructs the selected target SN by transmitting the SN RRCReconfigurationComplete*** to the target SN. In addition, the MN transmits the SN release request signaling to other unselected target candidate SNs to cancel the CPC.

8. In the case that the UE has some bearers that require SCG radio resources, the UE is synchronized with the selected SN (performs random access).

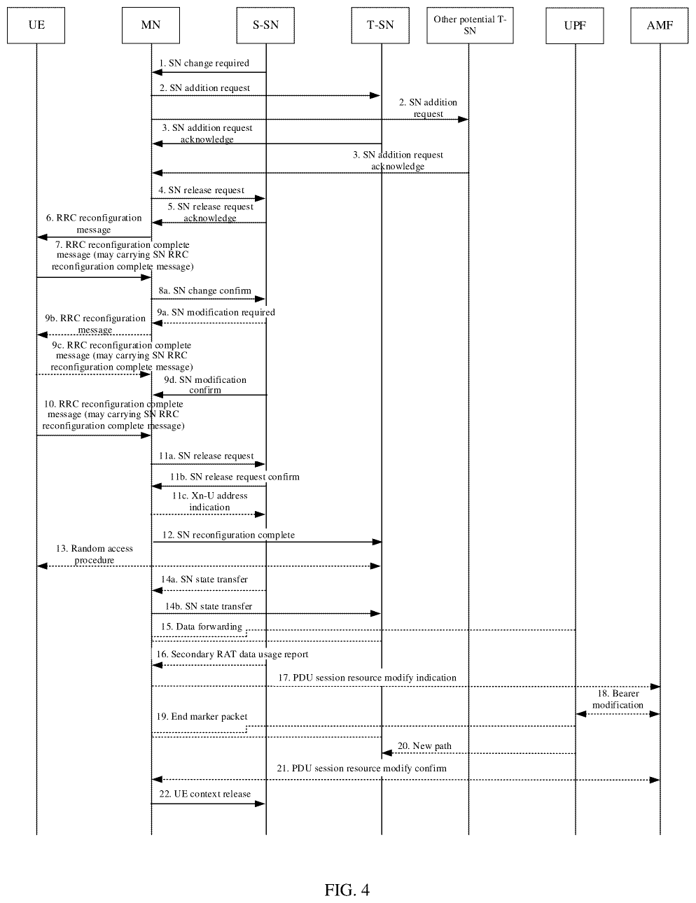

In some embodiments, the SN-initiated conditional SN change is as shown in FIG. 4. The SN-initiated conditional SN change process for configuring conditional PSCell change (CPC) configuration primarily includes the following steps.

1. The source SN initiates the conditional SN change process (sends the SN change required message to the MN). This signaling also includes the candidate target node ID. In addition, the signaling may also include: SCG configuration; measurement results submitted by the terminal; a list of cells including the proposed PSCell candidate cells and the corresponding execution conditions; and SCG measurement configuration (e.g., measurement ID required for CPC).

2/3. The MN requests the target SN to reserve resources through the SN addition process (including a CPC initiation indication, terminal measurement results, and a list of proposed PSCell candidate cells). The target SN selects, from the candidate cell list, the PSCell for which access resources need to be prepared. For each PSCell for which access resources are prepared, the SN decides the SCG SCell configuration and transmits the new SCG radio resource configuration to the MN (over the NR RRC configuration message carried in the SgNB addition request ACK message). In the case that data forwarding is required, the target SN transmits the data forwarding address to the MN.

4. The MN may need to transmit the candidate PSCell accepted by the target SN to the source SN (over SN change request signaling).

5. The source SN may provide an updated measurement configuration and corresponding CPC execution conditions to the MN (over SN change request ACK signaling).

6. The MN transmits the list including the CPC configuration information (i.e., including the RRCConnectionReconfiguration**) and the corresponding primary secondary cell change conditions to the terminal. The RRCConnectionReconfiguration** includes the RRCReconfiguration*** configuration information of the candidate SN and the existing MCG update configuration information (including the measurement configuration information that needs to be executed).

7. The terminal applies the RRC configuration included in the RRCConnectionReconfiguration* in addition to the CPC configuration, stores the CPC configuration information, and transmits the RRCConnectionReconfigurationComplete message back to the MN.

8a. The MN transmits the RRCReconfigurationComplete** signaling to the source SN (over the SN change confirm signaling) to notify that the CPC is ready. In the case that early data forwarding is required, the MN needs to transmit the data forwarding address received from the target SN to the source SN. The source SN, if possible, initiates early data forwarding. In the case that multiple target SNs (T-SNs) are present, the MN transmits their identities (IDs) and address information to the source SN (S-SN).

9a. The S-SN transmits an SN modification request.

9b. The MN transmits an RRC reconfiguration message to the UE (which may carry the S-SN RRC reconfiguration message, and carry the MN RRC reconfiguration message and the T-SN RRC reconfiguration message).

9c. The UE transmits an RRC reconfiguration complete message to the MN (which may carry the S-SN RRC reconfiguration message).

9d. The MN transmits an SN modification confirmation to the S-SN.

10. The UE starts evaluating the execution conditions. In the case that the execution condition of one candidate PSCell is met, the terminal applies the RRCConnctionReconfiguration signaling (RRCConnectionReconfiguration**) of the selected candidate cell, and transmits the RRCConnectionReconfigurationComplete signaling (including the information of the selected PSCell) to the MN.

11a-11c. The MN informs the source SN to stop providing terminal data to the terminal through the MN initiated SN release process, and initiates the Xn-U address indication process to transmit the address of the selected target SN to the source SN. If possible, the source SN initiates late data forwarding.

12. In the case that the RRC connection reconfiguration process in step 10 is successful, the MN notifies the selected target SN (by transmitting the SN RRCReconfigurationComplete*** to the target SN). In addition, the MN transmits an SN release request signaling to other unselected target candidate SNs to cancel the CPC.

13. The terminal performs random access to access the target PSCell.

To better understand the embodiments of the present disclosure, the differences between the conditional PSCell change related to the present disclosure and the conventional PSCell change are explained.

The conventional PSCell change requires the terminal to first report the measurement results, then the MN communicates with the target SN based on the measurement results, and subsequently transmits the access resources reserved by the SN for the target PSCell to the terminal to enable the terminal to access the target SN. For the conditional PSCell addition, the MN may communicate in advance with the candidate target SNs (possibly more than one) to reserve resources and transmit the resources to the terminal, and transmit the signal threshold conditions for performing the PSCell change and the information of the candidate target PSCells to the terminal. In the case that the conditions are met, the terminal may autonomously perform the PSCell change operation.

However, it should be noted that for both conventional PSCell change and conditional PSCell change, the signal thresholds corresponding to the same reporting/execution events are different. It is easy to understand that the terminal experiences a shorter time for the conditional PSCell change, so the terminal should perform the operation closer to the target PSCell. For the conventional process, the terminal takes a longer time to start the operation, so the terminal needs to report the event earlier, as shown in FIG. 5.

For a better understanding of the embodiments of the present disclosure, the SCG failure information report related to the present disclosure is explained.

In the case that the terminal encounters a random access issue when accessing the new PSCell or encounters a radio link failure issue shortly upon accessing the target PSCell, the terminal will report the SCG failure information report to the master node (MN) that provided the measurement configuration, to help the network subsequently adjust the signal threshold trigger condition of PSCell addition for terminal.

Specifically, the reported specific content in the SCG failure message report includes the following content.

Failure type enumeration (failuretype ENUMERATED) {timer t310 expiry (t310-expiry), random access problem (randomAccessProblem), radio link control (RLC) maximum retransmission count (rlc-MaxNumRetx), SCG synchronization reconfiguration failure (synchReconfigFailureSCG), SCG reconfiguration failure (scg-ReconfigFailure), signaling radio bearer 3 (SRB3) integrity failure (srb3-IntegrityFailure)} - - - indicates the cause of the failure, which mainly fall into two categories: radio link failure (RLF) due to poor air interface link quality, and the random access issue when accessing the target network.

Measurement result frequency list (measResultFreqList): including the measurement result on the NR frequency that the UE is configured to measure by the MN.

Location Information: the geographical location of the terminal when the SCG failure occurs.

SCG measurement result failure (measResultSCG-Failure): the measurement result of the measurement configured by the NR SCG RRCReconfiguration message.

Previous PSCell identity (PreviousPSCellID): the source cell ID in the last SN change.

Failed PSCell identity (failedPSCellID): the cell identity at the time the last SCGfailure was detected, or the target PSCell identity in the failed PSCell change.

In an NR system, stricter requirements are imposed on the conditional PSCell change. Therefore, how to optimize the conditional PSCell change is a problem to be solved.

For a better understanding of the embodiments of the present disclosure, the problems addressed by the present disclosure are explained.

Currently, no relevant optimization process for the conditional PSCell change, and the content of the SCG failure information report is very limited. The network does not know how long to reserve access resources for the terminal, nor whether the timing of the terminal's candidate PSCell change is appropriate, which may lead to SCG failures. Alternatively, the terminal requests a PSCell change again shortly thereafter, all of which require terminal feedback to help the network adjust parameters.

Based on the above issues, the present disclosure proposes solutions to optimize the conditional primary secondary cell change. The terminal device reports a primary secondary cell change report, such that the network device is capable of optimizing the conditional primary secondary cell change based on the primary secondary cell change report, and meanwhile the communication system is optimized.

The following details the technical solutions according to the present disclosure through specific embodiments.

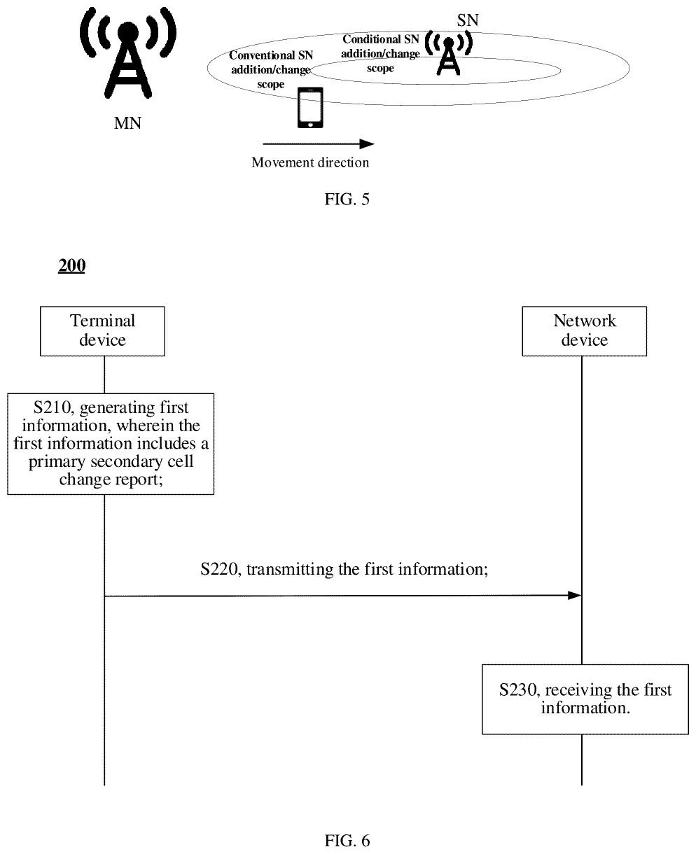

FIG. 6 is a schematic flowchart of a method 200 for processing resources according to some embodiments of the present disclosure. As shown in FIG. 6, the method 200 may include at least part of the following contents.

In S210, a terminal device generates first information, wherein the first information includes a primary secondary cell change report.

In S220, the terminal device transmits the first information.

In S230, the network device receives the first information.

In the embodiments of the present disclosure, the network device optimizes the conditional primary secondary cell change based on the primary secondary cell change report. For example, the network device optimizes the trigger condition for the conditional primary secondary cell change and/or optimizes the duration and/or quantity of resources reserved for the conditional primary secondary cell change. In this way, the mobility and robustness of the conditional primary secondary cell change are enhanced, and the communication system is also optimized.

In some embodiments, the network device is an MN or a source SN.

In some embodiments, the primary secondary cell change report is a primary secondary cell change success report or a primary secondary cell change failure report.

In some embodiments, the first information is generated and transmitted upon successful completion of the PSCell change, or generated and transmitted upon failure of the PSCell change.

In some embodiments, the first information is an uplink information response (ULInformationResponse) or SCG failure information (SCGfailureInformation).

Specifically, for example, in the case that the primary secondary cell change report is a primary secondary cell change success report, the first information is an uplink information response (ULInformationResponse).

Specifically, for another example, in the case that the primary secondary cell change report is a primary secondary cell change failure report, the first information is SCG failure information (SCGfailureInformation).

In some embodiments, the first information is carried over one of: RRC signaling, uplink control information (UCI), or a medium access control (MAC) control element (CE).

In some embodiments, the primary secondary cell change report includes, but is not limited to at least one of: the identification information of the accessed primary secondary cell, the channel quality measurement result of the target primary secondary cell, the candidate primary secondary cell list, the location information of the terminal device, and the channel quality measurement result of the source primary secondary cell.

In some embodiments, the candidate primary secondary cell list in the primary secondary cell change report reported by many terminal devices in the same location to the network always includes cell A and cell B, but the channel quality measurement results of cell A and cell B never meet the execution condition for the primary secondary cell change, it indicates that the terminal devices at this location should not consider cell A and cell B as candidate primary secondary cells. When configuring conditional primary secondary cell changes in the future, the network device no longer requires the SN of cell A and cell B to allocate unnecessary radio resources. That is, the SN of cell A and cell B no longer reserves resources for conditional primary secondary cell change.

In some embodiments, the primary secondary cell change report includes, but is not limited to at least one of: the time from receiving the configuration information of the conditional primary secondary cell change to performing the primary secondary cell change, the location information of the terminal device when performing the conditional primary secondary cell change, and the location information of the terminal device prior to performing the conditional primary secondary cell change.

In some embodiments, the network device optimizes the duration for which each SN reserves resources with reference to the time from receiving the configuration information of the conditional primary secondary cell change to performing the primary secondary cell change reported by the terminal devices in the same location. Specifically, in the case that the network device determines that the terminal device does not perform the conditional primary secondary cell change (for example, in the case that the terminal device does not perform the conditional primary secondary cell change for a long time upon receiving the configuration information of the conditional primary secondary cell change, the network device determines that the terminal device does not perform the conditional primary secondary cell change), the network device (such as the MN) transmits a release request to the SN of the candidate primary secondary cell, thereby releasing the reserved resources.

In some embodiments, the primary secondary cell change report includes, but is not limited to at least one of: the neighbor cell channel quality measurement result including at least the channel quality measurement result of one candidate primary secondary cell, the event type and/or parameter information corresponding to the trigger condition for the primary secondary cell change configured for each candidate primary secondary cell, the event type and/or parameter information corresponding to the trigger condition for the primary secondary cell change, or the indication information used to instruct the terminal device to perform the conditional primary secondary cell change.

In some embodiments, in the case that the primary secondary cell change report is a primary secondary cell change failure report, the primary secondary cell change report includes, but is not limited to at least one of: the time from performing the conditional primary secondary cell change to the SCG failure, the most recently recorded location information of the terminal device when the SCG failure occurs, or the most recently recorded location information of the terminal device prior to occurrence of the SCG failure.

In some embodiments, in the case that the time from performing the conditional primary secondary cell change to the SCG failure reported by the terminal device is less than a preset threshold, the primary secondary cell change is considered as being executed late. The network device needs to adjust the execution condition parameters for the corresponding conditional primary secondary cell change based on the channel quality measurement result of the target primary secondary cell and the channel quality measurement result of the source primary secondary cell, such that the execution condition is more stringent.

In some embodiments, in the case that the primary secondary cell change report reported by the terminal device does not include the time from performing the conditional primary secondary cell change to the SCG failure, the conditional primary secondary cell change is considered as being executed late. The network needs to adjust the execution condition parameters for the corresponding conditional primary secondary cell change based on the neighbor cell channel quality measurement result including at least the channel quality measurement result of one candidate primary secondary cell and the channel quality measurement result of the source primary secondary cell, such that the execution condition is more lenient.

In some embodiments, the primary secondary cell change report includes, but is not limited to at least one of: the identification information of the accessed primary secondary cell, the channel quality measurement result of the target primary secondary cell, the candidate primary secondary cell list, the location information of the terminal device, the channel quality measurement result of the source primary secondary cell, the time from receiving the configuration information of the conditional primary secondary cell change to performing the primary secondary cell change, the location information of the terminal device when performing the conditional primary secondary cell change, the location information of the terminal device prior to performing the conditional primary secondary cell change, the neighbor cell channel quality measurement result including at least the channel quality measurement result of one candidate primary secondary cell, the event type and/or parameter information corresponding to the trigger condition for the primary secondary cell change configured for each candidate primary secondary cell, the event type and/or parameter information corresponding to the trigger condition for the primary secondary cell change, the indication information used to instruct the terminal device to perform the conditional primary secondary cell change, the time from performing the conditional primary secondary cell change to the SCG failure, the most recently recorded location information of the terminal device when the SCG failure occurs, or the most recently recorded location information of the terminal device prior to occurrence of the SCG failure.

In some embodiments, the primary secondary cell change report includes first sub-information and/or second sub-information.

The first sub-information is used to determine the duration and/or quantity of resources reserved for the terminal device during the conditional primary secondary cell change process, and the second sub-information is used to determine the trigger condition for the conditional primary secondary cell change.

In some embodiments, the reserved resource includes at least the contention-free random access preambles and/or random access time-frequency resources.

In some embodiments, the first sub-information includes at least one of: the time from receiving the configuration information of the conditional primary secondary cell change to performing the primary secondary cell change, the identification information of the accessed primary secondary cell, the channel quality measurement result of the target primary secondary cell, the neighbor cell channel quality measurement result including at least the channel quality measurement result of one candidate primary secondary cell, the candidate primary secondary cell list, the event type and/or parameter information corresponding to the trigger condition for the primary secondary cell change configured for each candidate primary secondary cell, or the location information of the terminal device.

In some embodiments, the second sub-information includes at least one of: the time from performing the conditional primary secondary cell change to the SCG failure, the location information of the terminal device when the SCG failure occurs, the location information of the terminal device prior to occurrence of the SCG failure, the location information of the terminal device when performing the conditional primary secondary cell change, the location information of the terminal device prior to performing the conditional primary secondary cell change, the event type and/or parameter information corresponding to the trigger condition for the primary secondary cell change, the neighbor cell channel quality measurement result including at least the channel quality measurement result of one or more candidate primary secondary cells, the candidate primary secondary cell list, the channel quality measurement result of the source primary secondary cell, the channel quality measurement result of the target primary secondary cell, or the indication information used to instruct the terminal device to perform the conditional primary secondary cell change.

In some embodiments, the channel quality measurement result includes, but is not limited to at least one of: a reference signal received power (RSRP), a reference signal received quality (RSRQ), or a signal-to-interference-plus-noise ratio (SINR).

In some embodiments, the event type according to the embodiments of the present disclosure includes, but is not limited to at least one of: A4 event or B1 event. It should be note that other events may also be included, which is not limited in the present disclosure.

In some embodiments, the primary secondary cell change report includes first indication information.

The first indication information indicates the configuration node of the conditional primary secondary cell change, or the first indication information indicates whether the configuration information of the conditional primary secondary cell change is configured by the MN, or the first indication information indicates whether the configuration information of the conditional primary secondary cell change is configured by the SN.

It should be noted that the execution condition for the conditional primary secondary cell change may be configured by the MN (such as the case that the MN initiates the SN change shown in FIG. 3), and the execution condition for the conditional primary secondary cell change may be configured by the SN (such as the case that the SN initiates the SN change shown in FIG. 4). To enable the primary secondary cell change report reported by the terminal device to arrive the place where the initial condition was set, the terminal device needs to identify in the primary secondary cell change report whether the received configuration of the conditional primary secondary cell change was originally sourced from/configured by the MN or the SN.

Specifically, in the case that the first indication information indicates that the configuration information of the conditional primary secondary cell change is configured by the SN, the MN needs to forward the primary secondary cell change report to the source SN upon receiving the primary secondary cell change report. That is, in this case, the network device may be the source SN.

In some embodiments, in the case that the primary secondary cell change report is a primary secondary cell change success report, the terminal device transmits or records the primary secondary cell change success report under at least one of the following trigger conditions:

the time from receiving the conditional primary secondary cell change command to performing the conditional primary secondary cell change is greater than a first threshold; or

the time from starting to perform the conditional primary secondary cell change to completing the conditional primary secondary cell change is greater than a second threshold.

In some embodiments, the first threshold is configured by the network device, or the first threshold is stipulated by protocol.

In some embodiments, the second threshold is configured by the network device, or the second threshold is stipulated by protocol.

In some embodiments, the terminal device transmits second indication information, wherein the second indication information indicates that the primary secondary cell change report to be reported is present in the terminal device.

Specifically, the terminal device transmits the second indication information to the MN to inform the MN that the primary secondary cell change report to be reported is present in the terminal device. For example, the terminal device informs the network that a to-be-reported primary secondary cell change failure report is present using a bit in the SCG failure information (SCGfailureInformation). For another example, the terminal device informs the network that a to-be-reported primary secondary cell change success report is present using other RRC signaling.

In some embodiments, the terminal device receives first request information, wherein the first request information is used to request the terminal device to report the primary secondary cell change report.

In some embodiments, the first request information is carried by one of: RRC signaling, downlink control information (DCI), or a MAC CE.

Therefore, in the embodiments of the present disclosure, the network device is capable of optimizing the conditional primary secondary cell change based on the primary secondary cell change report, for example, by optimizing the trigger condition for the conditional primary secondary cell change, and/or by optimizing the duration and/or quantity of resources reserved for the conditional primary secondary cell change. In this way, the mobility and robustness of the conditional primary secondary cell change are enhanced, while the communication system is also optimized.

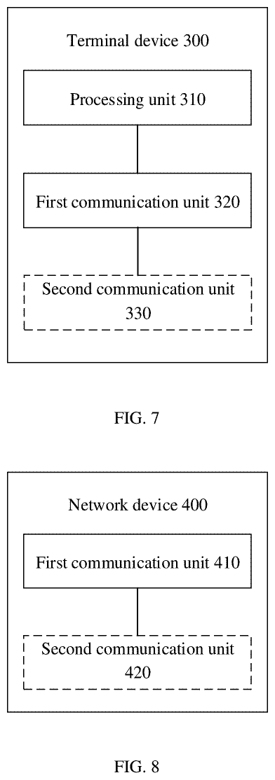

The method embodiments of the present disclosure have been described in detail above with reference to FIG. 6, and apparatus embodiments of the present disclosure are described in detail below with reference to FIGS. 7 to 11. It should be understood that the apparatus embodiments correspond to the method embodiments, and for similar descriptions, reference may be made to the method embodiments.

FIG. 7 illustrates a schematic block diagram of a terminal device 300 according to some embodiments of the present disclosure. As shown in FIG. 7, the terminal device 300 includes a processing unit 310 and a first communication unit 320.

The processing unit 310 is configured to generate first information, where the first information includes a primary secondary cell change report.

The first communication unit 320 is configured to transmit the first information.

In some embodiments, the primary secondary cell change report includes at least one of: the identification information of the accessed primary secondary cell, the channel quality measurement result of the target primary secondary cell, the candidate primary secondary cell list, the location information of the terminal device, or the channel quality measurement result of the source primary secondary cell.

In some embodiments, the primary secondary cell change report includes at least one of: the time from receiving the configuration information of the conditional primary secondary cell change to performing the primary secondary cell change, the location information of the terminal device when performing the conditional primary secondary cell change, or the location information of the terminal device prior to performing the conditional primary secondary cell change.

In some embodiments, the primary secondary cell change report includes at least one of:

the neighbor cell channel quality measurement result including at least the channel quality measurement result of one candidate primary secondary cell, the event type and/or parameter information corresponding to the trigger condition for the primary secondary cell change configured for each candidate primary secondary cell, the event type and/or parameter information corresponding to the trigger condition for the primary secondary cell change, or the indication information used to instruct the terminal device to perform the conditional primary secondary cell change.

In some embodiments, in the case that the primary secondary cell change report is a primary secondary cell change failure report, the primary secondary cell change report includes at least one of: the time from performing the conditional primary secondary cell change to the secondary cell group (SCG) failure, the most recently recorded location information of the terminal device when the SCG failure occurs, or the most recently recorded location information of the terminal device prior to occurrence of the SCG failure.

In some embodiments, the channel quality measurement result includes at least one of: a reference signal received power (RSRP), a reference signal received quality (RSRQ), or a signal-to-interference-plus-noise ratio (SINR).

In some embodiments, the primary secondary cell change report includes first indication information.

The first indication information indicates the configuration node of the conditional primary secondary cell change, or the first indication information indicates whether the configuration information of the conditional primary secondary cell change is configured by the master node (MN), or the first indication information indicates whether the configuration information of the conditional primary secondary cell change is configured by the secondary node (SN).

In some embodiments, in the case that the primary secondary cell change report is a primary secondary cell change success report, the first communication unit 320 is further configured to transmit the primary secondary cell change success report or the processing unit 310 is configured to record the primary secondary cell change success report under at least one of the following trigger conditions:

the time from receiving the conditional primary secondary cell change command to performing the conditional primary secondary cell change is greater than a first threshold; or

the time from starting to perform the conditional primary secondary cell change to completing the conditional primary secondary cell change is greater than a second threshold.

In some embodiments, the first communication unit 320 is further configured to transmit second indication information, wherein the second indication information indicates that the primary secondary cell change report to be reported is present in the terminal device.

In some embodiments, the terminal device 300 further includes a second communication unit 330.

The second communication unit 330 is configured to receive first request information, wherein the first request information is used to request the terminal device to report the primary secondary cell change report.

In some embodiments, the primary secondary cell change report is a primary secondary cell change success report, or the primary secondary cell change report is a primary secondary cell change failure report.

In some embodiments, the above communication unit is a communication interface or a transceiver, or an input-output interface of a communication chip or system on chip. The above processing unit includes one or more processors.

It should be understood that the terminal device 300 according to the embodiments of the present disclosure may correspond to the terminal device in the method embodiments of the present disclosure, and the above and other operations and/or functions of the units in the terminal device 300 are separately for implementing corresponding flows of the terminal device in the method 200 shown in FIG. 6, which is not described herein any further for brevity.

FIG. 8 illustrates a schematic block diagram of a network device 400 according to some embodiments of the present disclosure. As shown in FIG. 8, the network device 400 includes a first communication unit 410.

The first communication unit 410 is configured to receive first information, wherein the first information includes a primary secondary cell change report.

In some embodiments, the primary secondary cell change report includes at least one of: the identification information of the accessed primary secondary cell, the channel quality measurement result of the target primary secondary cell, the candidate primary secondary cell list, the location information of the terminal device, or the channel quality measurement result of the source primary secondary cell.

In some embodiments, the primary secondary cell change report includes at least one of: the time from receiving the configuration information of the conditional primary secondary cell change to performing the primary secondary cell change, the location information of the terminal device when performing the conditional primary secondary cell change, or the location information of the terminal device prior to performing the conditional primary secondary cell change.

In some embodiments, the primary secondary cell change report includes at least one of:

the neighbor cell channel quality measurement result including at least the channel quality measurement result of one candidate primary secondary cell, the event type and/or parameter information corresponding to the trigger condition for the primary secondary cell change configured for each candidate primary secondary cell, the event type and/or parameter information corresponding to the trigger condition for the primary secondary cell change, or the indication information used to instruct the terminal device to perform the conditional primary secondary cell change.

In some embodiments, in the case that the primary secondary cell change report is a primary secondary cell change failure report, the primary secondary cell change report includes at least one of: the time from performing the conditional primary secondary cell change to the secondary cell group (SCG) failure, the most recently recorded location information of the terminal device when the SCG failure occurs, or the most recently recorded location information of the terminal device prior to occurrence of the SCG failure.

In some embodiments, the channel quality measurement result includes at least one of: a reference signal received power (RSRP), a reference signal received quality (RSRQ), or a signal-to-interference-plus-noise ratio (SINR).

In some embodiments, the primary secondary cell change report includes first indication information.

The first indication information indicates the configuration node of the conditional primary secondary cell change, or the first indication information indicates whether the configuration information of the conditional primary secondary cell change is configured by the master node (MN), or the first indication information indicates whether the configuration information of the conditional primary secondary cell change is configured by the secondary node (SN).

In some embodiments, in the case that the primary secondary cell change report is a primary secondary cell change success report, the first communication unit 410 is configured to receive the first information under at least one of the following trigger conditions:

the time from receiving the conditional primary secondary cell change command to performing the conditional primary secondary cell change is greater than a first threshold, or the time from starting to perform the conditional primary secondary cell change to completing the conditional primary secondary cell change is greater than a second threshold.

In some embodiments, the first communication unit 410 is further configured to receive second indication information, wherein the second indication information indicates that the primary secondary cell change report to be reported is present in the terminal device.

In some embodiments, the network device 400 further includes a second communication unit 420.

The second communication unit 420 is configured to transmit first request information, wherein the first request information is used to request the terminal device to report the primary secondary cell change report.

In some embodiments, the primary secondary cell change report is a primary secondary cell change success report, or the primary secondary cell change report is a primary secondary cell change failure report.

In some embodiments, the network device is an MN, or the network device is a source SN.

In some embodiments, the above communication unit is a communication interface or a transceiver, or an input-output interface of a communication chip or system on chip. The above processing unit includes one or more processors.

It should be understood that the network device 400 according to the embodiments of the present disclosure may correspond to the network device in the method embodiments of the present disclosure, and the above and other operations and/or functions of the units in the network device 400 are separately for implementing corresponding flows of the network device in the method 200 shown in FIG. 6, which is not described herein any further for brevity.

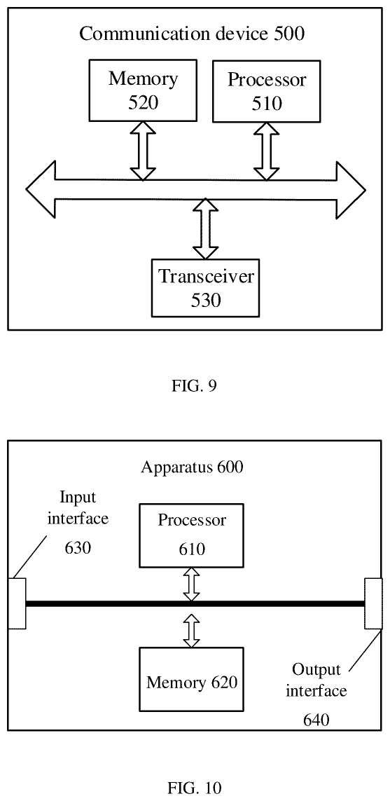

FIG. 9 is a schematic structural diagram of a communication device 500 according to some embodiments of the present disclosure. The communication device 500 shown in FIG. 9 includes a processor 510. The processor 510 calls and runs a computer program from a memory to implement the methods according to the embodiments of the present disclosure.

In some embodiments, as shown in FIG. 9, the communication device 500 further includes a memory 520. The processor 510, when loading and running the computer program from the memory 520, is caused to implement the methods according to the embodiments of the present disclosure.

The memory 520 is a separate device independent from the processor 510 or is integrated within the processor 510.

In some embodiments, as shown in FIG. 9, the communication device 500 further includes a transceiver 530. The processor 510 controls the transceiver 530 to communicate with other devices, specifically, to transmit information or data to other devices, or to receive information or data from other devices.

The transceiver 530 includes a transmitter and a receiver. The transceiver 530 further includes one or more antennas.

In some embodiments, the processor 510 implements the functions of the processing unit in the terminal device, or implements the functions of the processing unit in the network device. For brevity, details are not described herein any further.

In some embodiments, the transceiver 530 implements the functions of the first communication unit and/or the second communication unit in the terminal device. For brevity, details are not described herein any further.

In some embodiments, the transceiver 530 implements the functions of the first communication unit and/or the second communication unit in the network device. For brevity, details are not described herein any further.

In some embodiments, the communication device 500 is specifically the network device in the embodiments of the present disclosure, and the communication device 500 implements the corresponding processes of the methods implemented by the network device in the embodiments of the present disclosure. For brevity, details are not described herein any further.

In some embodiments, the communication device 500 is specifically the terminal device in the embodiments of the present disclosure, and the communication device 500 implements the corresponding processes of the methods implemented by the terminal device in the embodiments of the present disclosure. For brevity, details are not described herein any further.

FIG. 10 is a schematic structural diagram of an apparatus according to some embodiments of the present disclosure. The apparatus 600 shown in FIG. 10 includes a processor 610. The processor 610, when loading and running one or more computer programs from a memory, is caused to implement the methods in the embodiments of the present disclosure.

In some embodiments, as shown in FIG. 10, the apparatus 600 further includes a memory 620. The processor 610, when loading and running one or more computer programs from the memory 620, is caused to implement the methods in the embodiments of the present disclosure.

The memory 620 is a separate device independent from the processor 610 or is integrated within the processor 610.

In some embodiments, the apparatus 600 further includes an input interface 630. The processor 610 controls the input interface 630 to communicate with other devices or chips, specifically, to acquire information or data from other devices or chips. In some embodiments, the processor 610 is located on-chip or off-chip.

In some embodiments, the processor 610 implements the functions of the processing unit in the terminal device, or implements the functions of the processing unit in the network device. For brevity, details are not described herein any further.

In some embodiments, the input interface 630 implements the functions of the communication unit in the terminal device, or implements the functions of the communication unit in the network device.

In some embodiments, the apparatus 600 also include an output interface 640. The processor 610 controls the output interface 640 to communicate with other devices or chips, specifically, to output information or data to other devices or chips. In some embodiments, the processor 610 is located on-chip or off-chip.

In some embodiments, the output interface 640 implements the functions of the communication unit in the terminal device, or implements the functions of the communication unit in the network device.

In some embodiments, the apparatus is applicable to the network device in the embodiments of the present disclosure, and the apparatus implements the corresponding processes of the methods implemented by the network device in the embodiments of the present disclosure. For brevity, details are not described herein any further.

In some embodiments, the apparatus is applicable to the terminal device in the embodiments of the present disclosure, and the apparatus implements the corresponding processes of the methods implemented by the terminal device in the embodiments of the present disclosure. For brevity, details are not described herein any further.

In some embodiments, the apparatus mentioned in the embodiments of the present disclosure is a chip. For example, the apparatus may be a system-level chip, a system chip, a chip system, a system-on-chip, and the like.

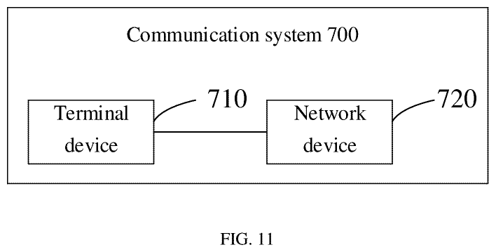

FIG. 11 is a schematic block diagram of a communication system 700 according to some embodiments of the present disclosure. As shown in FIG. 11, the communication system 700 includes a terminal device 710 and a network device 720.

The terminal device 710 is configured to implement the corresponding functions implemented by the terminal device in the above methods, and the network device 720 is configured to implement the corresponding functions implemented by the network device in the above methods. For brevity, details are not described herein any further.

It should be understood that the processor of the embodiments of the present disclosure may be an integrated circuit chip with signal processing capabilities. In implementation, the processes of the above method embodiments may be achieved by integrated logic circuits of hardware in the processor or instructions in the form of software. The above processor may be a general-purpose processor, a digital signal processor (DSP), an application specific integrated circuit (ASIC), a field programmable gate array (FPGA), or another programmable logic device, discrete gate or transistor logic device, or discrete hardware component. The methods, processes, and logic block diagrams according to the embodiments of the present disclosure can be implemented or performed. The general-purpose processor may be a microprocessor, any conventional processor, or the like. The processes of the methods according to the embodiments of the present disclosure may be directly embodied as being performed by a hardware decoding processor or being performed by a combination of hardware and software modules within the decoding processor. The software module may be disposed in a random access memory, a flash memory, a read-only memory, a programmable read-only memory, an electrically erasable programmable memory, a register, or other mature storage medium in the art. The storage medium is disposed in a memory, and the processor reads information from the memory and performs the processes of the above methods in combination with its hardware.

It should be understood that the memory in the embodiments of the present disclosure may be either a volatile memory or a non-volatile memory, or may include both volatile and non-volatile memories. The non-volatile memory may be a read-only memory (ROM), a programmable ROM (PROM), an erasable PROM (EPROM), an electrically EPROM (EEPROM), or a flash memory. The volatile memory may be a random access memory (RAM) which serves as an external cache. By way of example and not limitation, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that the memory of the systems and methods described herein is intended to include but is not limited to, these and any other suitable types of memories.

It should be understood that the above-mentioned memories are exemplary but not for limitation. For example, the memory in the embodiments of the present disclosure may also be an SRAM, a DRAM, an SDRAM, a DDR SDRAM, an ESDRAM, an SLDRAM, a DR RAM, or the like. That is, the memory in the embodiments of the present disclosure is intended to include but is not limited to, these and any other suitable types of memories.

The embodiments of the present disclosure further provide a computer-readable storage medium for storing one or more computer programs.

In some embodiments, the computer-readable storage medium is applicable to the network device in the embodiments of the present disclosure, and the one or more computer programs cause a computer to perform the corresponding processes implemented by the network device in the methods according to the embodiments of the present disclosure. For brevity, details are not described herein any further.

In some embodiments, the computer-readable storage medium is applicable to the terminal device in the embodiments of the present disclosure, and the one or more computer programs cause a computer to perform the corresponding processes implemented by the terminal device in the methods according to the embodiments of the present disclosure. For brevity, details are not described herein any further.

The embodiments of the present disclosure further provide a computer program product including one or more computer program instructions.

In some embodiments, the computer program product is applicable to the network device in the embodiments of the present disclosure, and the one or more computer program instructions cause a computer to perform the corresponding processes implemented by the network device in the various methods of the embodiments of the present disclosure. For brevity, details are not described herein any further.

In some embodiments, the computer program product is applicable to the terminal device in the embodiments of the present disclosure, and the one or more computer program instructions cause a computer to perform the corresponding processes implemented by the terminal device in the methods of the embodiments of the present disclosure. For brevity, details are not described herein any further.

The embodiments of the present disclosure further provide a computer program.

In some embodiments, the computer program is applicable to the network device in the embodiments of the present disclosure, and the computer program, when loaded and run by a computer, causes the computer to perform the corresponding processes implemented by the network device in the methods of the embodiments of the present disclosure. For brevity, details are not described herein any further.

In some embodiments, the computer program is applicable to the terminal device in the embodiments of the present disclosure, and the computer program, when loaded and run by a computer, causes the computer to perform the corresponding processes implemented by the terminal device in the methods of the embodiments of the present disclosure. For brevity, details are not described herein any further.

Those of ordinary skill in the art will understand that the units and algorithm processes of various examples described in conjunction with the embodiments disclosed herein can be implemented by electronic hardware, or a combination of computer software and electronic hardware. Whether these functions are performed by hardware or software depends on the specific application and design constraints of the technical solutions. Those skilled in the art may implement the described functions in varying ways for each specific application, but such implementations should not be considered beyond the scope of the present disclosure.

Those skilled in the art clearly understand that for convenience and brevity in description, for the specific working processes of the systems, apparatuses, and units described above, reference may be made to the corresponding processes in the above method embodiments, which are not repeated herein.

In the embodiments of the present disclosure, it should be understood that the disclosed systems, apparatuses, and methods may be implemented in other ways. For example, the above-described apparatus embodiments are merely illustrative. For example, the division of the units is only a logical functional division, and in actual implementation, there may be other division methods. For example, a plurality of units or components may be combined or integrated into another system, or some features may be omitted or not executed. In addition, the coupling, direct coupling, or communication connection between each other shown or discussed may be indirect coupling or communication connection via some interfaces, apparatuses, or units; or may be in electrical, mechanical, or other forms.

The units described as separate parts may or may not be physically separate, and parts displayed as units may or may not be physical units, that is, they may be disposed in one place or distributed across a plurality of network units. Some or all of the units may be selected according to actual needs to achieve the purpose of the solutions according to the embodiments.

In addition, the functional units in the embodiments of the present disclosure may be integrated into one processing unit, or the units may be physically present separately, or two or more units may be integrated into one unit.

The functions may be stored in a computer-readable storage medium in the case that they are implemented in the form of software functional units and sold or used as independent products. Based on such understandings, the technical solutions of the present disclosure substantially, or the part thereof that contributes to the prior art, or part of the technical solutions, may be embodied in the form of a software product. The computer software product is stored in a storage medium and includes instructions for causing a computer device (which may be a personal computer, a server, a network device, or the like) to perform all or part of the processes of the methods in the various embodiments of the present disclosure. The above storage media include various medium capable of storing program codes, such as a U-disk, a mobile hard disk, a ROM, a RAM, a magnetic disk, or an optical disk.

The above descriptions are only specific embodiments of the present disclosure, but the protection scope of the present disclosure is not limited to these. Any variations or substitutions readily derived by those skilled in the art within the technical scope of the present disclosure should be covered within the protection scope of the present disclosure. Therefore, the protection scope of the present disclosure shall be subject to the protection scope of the claims.

1. A method for processing resources, applicable to a terminal device, the method comprising:
generating first information, wherein the first information comprises a primary secondary cell change report; and
transmitting the first information.

2. The method according to claim 1, wherein the primary secondary cell change report comprises at least one of:
a time from receiving configuration information of a conditional primary secondary cell change to performing a primary secondary cell change;
location information of the terminal device when performing the conditional primary secondary cell change; or
location information of the terminal device prior to performing the conditional primary secondary cell change.

3. The method according to claim 1, wherein the primary secondary cell change report comprises at least one of:
a neighbor cell channel quality measurement result comprising at least a channel quality measurement result of one candidate primary secondary cell;
at least one of an event type or parameter information corresponding to a trigger condition for a primary secondary cell change configured for each candidate primary secondary cell;
at least one of an event type or parameter information corresponding to a trigger condition for a primary secondary cell change; or
indication information used to instruct the terminal device to perform a conditional primary secondary cell change.

4. The method according to claim 1, wherein in a case that the primary secondary cell change report is a primary secondary cell change failure report, the primary secondary cell change report comprises at least one of:
a time from performing a conditional primary secondary cell change to a secondary cell group (SCG) failure;
most recently recorded location information of the terminal device when an SCG failure occurs; or
most recently recorded location information of the terminal device prior to occurrence of an SCG failure.

5. The method according to claim 1, wherein the primary secondary cell change report comprises first indication information;
wherein the first indication information indicates a configuration node of a conditional primary secondary cell change, or indicates whether configuration information of a conditional primary secondary cell change is configured by a master node (MN), or indicates whether configuration information of a conditional primary secondary cell change is configured by a secondary node (SN).

6. The method according to claim 1, further comprising:
in a case that the primary secondary cell change report is a primary secondary cell change success report, transmitting or recording the primary secondary cell change success report under at least one of the following trigger conditions:
a time from receiving a conditional primary secondary cell change command to performing a conditional primary secondary cell change is greater than a first threshold; or
a time from starting to perform a conditional primary secondary cell change to completing the conditional primary secondary cell change is greater than a second threshold.

7. The method according to claim 1, further comprising:
transmitting second indication information, wherein the second indication information indicates that the primary secondary cell change report to be reported is present in the terminal device.

8. A terminal device, comprising: a processor and a memory, wherein the memory is configured to store one or more computer programs, wherein the processor, when loading and running the one or more computer programs stored in the memory, causes the terminal device to perform:
generating first information, wherein the first information comprises a primary secondary cell change report; and
transmitting the first information.

9. The terminal device according to claim 8, wherein the primary secondary cell change report comprises at least one of:
a time from receiving configuration information of a conditional primary secondary cell change to performing a primary secondary cell change;
location information of the terminal device when performing the conditional primary secondary cell change; or
location information of the terminal device prior to performing the conditional primary secondary cell change.

10. The terminal device according to claim 8, wherein the primary secondary cell change report comprises at least one of:
a neighbor cell channel quality measurement result comprising at least a channel quality measurement result of one candidate primary secondary cell;
at least one of an event type or parameter information corresponding to a trigger condition for a primary secondary cell change configured for each candidate primary secondary cell;
at least one of an event type or parameter information corresponding to a trigger condition for a primary secondary cell change; or
indication information used to instruct the terminal device to perform a conditional primary secondary cell change.

11. The terminal device according to claim 8, wherein in a case that the primary secondary cell change report is a primary secondary cell change failure report, the primary secondary cell change report comprises at least one of:
a time from performing a conditional primary secondary cell change to a secondary cell group (SCG) failure;
most recently recorded location information of the terminal device when an SCG failure occurs; or
most recently recorded location information of the terminal device prior to occurrence of an SCG failure.

12. The terminal device according to claim 8, wherein the primary secondary cell change report comprises first indication information;
wherein the first indication information indicates a configuration node of a conditional primary secondary cell change, or indicates whether configuration information of a conditional primary secondary cell change is configured by a master node (MN), or indicates whether configuration information of a conditional primary secondary cell change is configured by a secondary node (SN).

13. The terminal device according to claim 8, wherein the processor, when loading and running the one or more computer programs stored in the memory, causes the terminal device to further perform:
in a case that the primary secondary cell change report is a primary secondary cell change success report, transmit or record the primary secondary cell change success report under at least one of the following trigger conditions:
a time from receiving a conditional primary secondary cell change command to performing a conditional primary secondary cell change is greater than a first threshold; or
a time from starting to perform a conditional primary secondary cell change to completing the conditional primary secondary cell change is greater than a second threshold.

14. The terminal device according to claim 8, wherein the processor, when loading and running the one or more computer programs stored in the memory, causes the terminal device to further perform:
receiving first request information, wherein the first request information is used to request the terminal device to report the primary secondary cell change report.

15. A network device, comprising: a processor and a memory, wherein the memory is configured to store one or more computer programs, wherein the processor, when loading and running the one or more computer programs stored in the memory, causes the network device to perform:
receiving first information, wherein the first information comprises a primary secondary cell change report.

16. The network device according to claim 15, wherein the primary secondary cell change report comprises at least one of:
a time from receiving configuration information of a conditional primary secondary cell change to performing a primary secondary cell change;
location information of the terminal device when performing the conditional primary secondary cell change; or
location information of the terminal device prior to performing the conditional primary secondary cell change.

17. The network device according to claim 15, wherein the primary secondary cell change report comprises at least one of:
a neighbor cell channel quality measurement result comprising at least a channel quality measurement result of one candidate primary secondary cell;
at least one of an event type or parameter information corresponding to a trigger condition for a primary secondary cell change configured for each candidate primary secondary cell;
at least one of an event type or parameter information corresponding to a trigger condition for a primary secondary cell change; or
indication information used to instruct the terminal device to perform a conditional primary secondary cell change.

18. The network device according to claim 15, wherein in a case that the primary secondary cell change report is a primary secondary cell change failure report, the primary secondary cell change report comprises at least one of:
a time from performing a conditional primary secondary cell change to a secondary cell group (SCG) failure;
most recently recorded location information of the terminal device when an SCG failure occurs; or
most recently recorded location information of the terminal device prior to occurrence of an SCG failure.

19. The network device according to claim 15, wherein the primary secondary cell change report comprises first indication information;
wherein the first indication information indicates a configuration node of a conditional primary secondary cell change, or the first indication information indicates whether configuration information of a conditional primary secondary cell change is configured by a master node (MN), or the first indication information indicates whether configuration information of a conditional primary secondary cell change is configured by a secondary node (SN).

20. The network device according to claim 15, further comprising:
in a case that the primary secondary cell change report is a primary secondary cell change success report, receiving the first information under at least one of the following trigger conditions:
a time from receiving a conditional primary secondary cell change command to performing a conditional primary secondary cell change is greater than a first threshold; or
a time from starting to perform a conditional primary secondary cell change to completing the conditional primary secondary cell change is greater than a second threshold.
